(19) United States
(12) Patent Application Publication
(10) Pub. No.: US 2004/0155517 A1
(43) Pub. Date: Aug. 12, 2004

(54) Self-assembled hybrid compositions and methods of making, using and ordering the same

(76) Inventors: Samuel I. Stupp, Chicago, IL (US); Leiming Li, Evanston, IL (US); Elia Beniash, Auburndale, MA (US); Eugene R. Zubarev, Ames, IA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/625,123

(22) Filed: Jul. 23, 2003

Related U.S. Application Data
(60) Provisional application No. 60/397,800, filed on Jul. 23, 2002.

(51) Int. Cl. C09K 11/02; B60B 23/00; B60B 25/00; G03C 1/00; G03B 11/00; G02C 7/10; G02B 5/02; C09K 19/52; F21V 9/00

(52) U.S. Cl. 301/17; 252/301.36; 252/301.35; 252/582; 252/299.01; 428/917

(57) ABSTRACT

The present invention is directed to self-assembled compositions forming one dimensional structures that include one or more guest species and method for making such materials. The self-assembling molecules form a self-assembled gel structure that is birefringent and made up from one dimensional structures like nanoribbons with the guest species dispersed throughout the gel. The guest species include nanocrystals, molecules, or other nanometer sized compounds. A ribbon polymer-inorganic nanocrystal hybrid, and a method of creating a ribbon polymer-inorganic crystal hybrid as well as a method of ordering the same to form an ultraviolet lasing media is disclosed.

### CROSS REFERENCES TO RELATED APPLICATIONS

This application claims priority from U.S. Provisional Application Serial No. 60/397,800 filed Jul. 23, 2002 the contents of which are incorporated herein by reference in their entirety.

### GOVERNMENT INTERESTS

The United States Government may have certain rights to this invention pursuant to work funded thereby at Northwestern University under grants from the Department of Energy Grant No. DE-FG02-00ER45810/A001 and the Army Research Office Grant No. DAAG55-97-1-0126.

### BACKGROUND OF THE INVENTION

An important direction in nanomaterial and supramolecular materials science is the development of general synthetic strategies for the creation of new materials and devices whose properties may be tailored and controlled. Supramolecular materials are one subset of designed organic materials in which the constituent units are groups of molecules that achieve a specific shape and size. Examples of one dimensional supramolecular structures are nanofibers, nanoribbons, and carbon nanotubes. One dimensional supramolecular structures could be very useful as scaffolds, or as shuttles for ions or molecules in microfluidics or between cells in biomedical sensors or devices.

The fabrication of nanomaterials and nanodevices based on supramolecular materials will be an important aspect and challenge in the commercialization of this technology. The ability to fabricate materials and devices with nanometer size features and components currently include lithography and membrane based synthetic methodologies. Self-assembly and templated mineralization are examples of emerging techniques for fabrication of molecular sized templates, composite materials, and the encapsulation of compounds. Polymeric matrices incorporating molecules have been investigated as a method for preparing new materials and controlling the orientation of the molecules. However these material composites often relax due to heating of the polymer with subsequent loss of the orientation of the molecules and their order in the polymeric matrix. Preformed templates such as zeolites have also been investigated to orient molecules within their channels, however these systems are limited by the size of their channels and are less flexible with respect to incorporation, of various sized guests. Mixing of ceramic nanoparticles in a polymer matrix has been used to form conductive polymer electrolytes. Preparing these composite materials is difficult due the extensive mixing required to disperse the nanoparticles homogenously in the polymer and because of the tendency of the nanoparticles to agglomerate. The reliable and inexpensive mass production of composite materials with nanrometer size particles and the formation of devices with nanometer sized features with controlled orientation and composition will be an important challenge in their manufacture. Controlling the arrangement of the molecules and atoms in nano and supramolecular devices will ultimately control the properties of these devices.

It would be desirable to self assemble supramolecular composite materials whose structure and properties can be controlled through self assembly. The fabrication of the materials should be easy to perform and the materials that are formed should be capable of maintaining long term structural order.

### SUMMARY OF THE INVENTION

The present invention is directed compounds or molecules that have the ability to self assemble and distribute guest species within the self assembled composition. The guest species may be oriented or aligned within the composition. The present compounds are of a nanoscale dimension, and preferably self assemble to form one dimensional structures. The self-assembled nanostructures of the present invention provide a template for interaction with other nanometer sized guest molecules, nanocrystals, or clusters and the constituent units may be further ordered by external electrical or magnetic fields.

The present invention is also directed to self-assembling compounds that improve the properties of a lasing material and can also form polarized photoluminescence (PL) materials and polarized electroluminescence (EL) materials.

One aspect of the present invention is the interaction of the strands or ribbons of self-assembled molecules with nanometer sized guest species having an elongated shape. The elongated guest species, for example rod shaped semiconductor nanocrystals or linear-shaped photoluminescent and electroluminescent dye molecules, are spontaneously dispersed throughout the self assembled gel material during its formation.

One embodiment of the present invention includes semiconductor nanocrystals or molecules with chromophores dispersed in a gel of a one dimensional nanoribbon formed from the self assembly of dendron rodcoil, DRC, molecules. These dendron rodcoil molecules include a branched block dendron segment, a rigid block rod segment, and a flexible block coil segment and where the bonds between the blocks are covalent bonds.

In a preferred embodiment of the present invention, a lasing media is formed, more preferably a ribbon polymer-inorganic crystal hybrid ultraviolet (UV) lasing media, and in another embodiment a method of making the ribbon polymer-inorganic crystal hybrid ultraviolet (UV) lasing media organized by self-assembly and electrophoresis.

Various aspects and applications of the present invention will become apparent to the skilled artisan upon consideration of the brief description of the figures and the detailed description of the invention, which follows.

### BRIEF DESCRIPTION OF THE DRAWINGS

FIG. 1 illustrates a 2% (wt/wt) ZnO-2% (wt/wt) DRC-EHMA gel (left) and a 2 wt % DRC-ERMA gel (right);

FIG. 2 illustrates poling of the gel with a 1500 V/cm electric field applied to the gel, (a) the gel before poling, and (b) the gel after poling;

FIG. 3 illustrates absorption (%) anisotropy (spectrum shift) for ZnO nanocrystals embedded in a poled DRC nanoribbon film formed as illustrated in FIG. 2;

FIG. 4 illustrates the increased pumping powers (In of pumping laser pulse energy) induce emissions intensity growth from the embedded ZnO nanocrystals in the poled DRC-ZnO film ultimately formed, and from the pure ZnO nanocrystals as a control. The graph illustrates that pure ZnO nanocrystals have a much higher lasing threshold than the poled ZnO in DRC nanoribbons.

FIG. 5 illustrates the chemical structure of a DRC molecule useful in accordance with the present invention.

FIG. 6 illustrates DRC gels containing disperse red 1 dyes (left) and phenylene vinylene molecules (right).

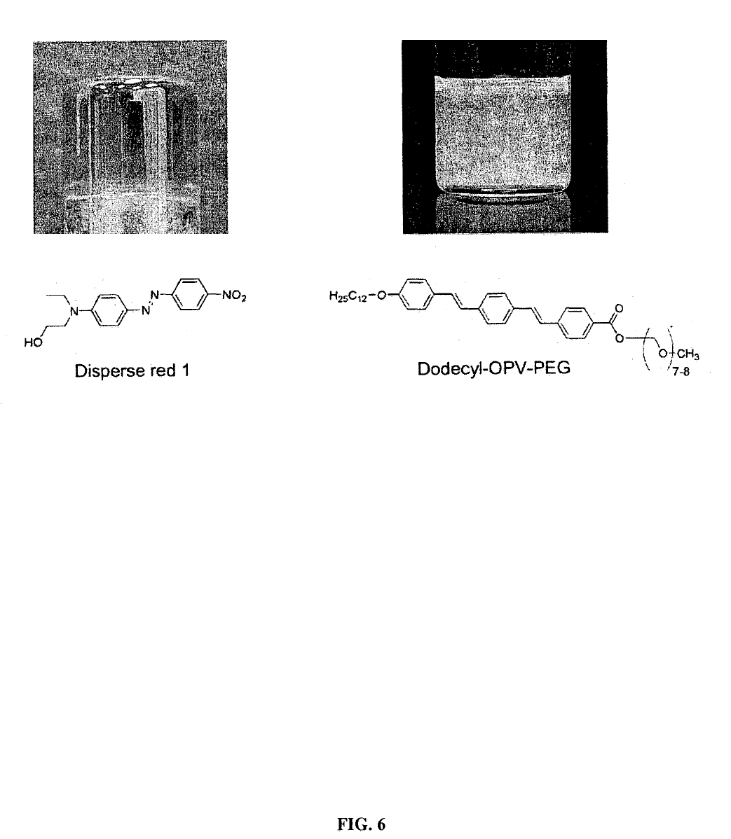

FIG. 7 illustrates enhanced photoluminescence polarization for poled disperse red 1-DRC films compared with 200%, 650%, and 2200% stretched dispersed red 1-polystyrene samples

### DETAILED DESCRIPTION OF THE INVENTION

Before the present compositions and methods are described, it is to be understood that this invention is not limited to the particular molecules, compositions, methodologies or protocols described herein, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a” “an” and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

Embodiments of the present invention are self-assembled compositions that include a combination of one or more guest species and self-assembling molecules. The self-assembling molecules form a self-assembled gel structure that is preferably birefringent and made up from one dimensional structures like nanoribbons with the guest species dispersed throughout the gel. The guest species may be nanocrystals, colloids, molecules, or other nanometer sized compounds that preferably have an elongated, rod like, or approximately linear shape. The self assembled gel with the dispersed guest preferably has an axis or the elongated portion of the guest molecule aligned approximately along the length of the one dimensional structures that make up the gel. Alignment of the nanoribbons and guest molecules in the gel may be achieved by application of an electric field to the gel.

The present invention may also be used for dispersing a variety of guest species in a gel matrix by combining the guest species with self assembling molecules to form a mixture and then allowing the self assembling molecules to self assemble into a gel. The guest species are distributed throughout the gel by the self assembling and gelation process. The distributed nanometer size guest species may be oriented within the gel by application of an electric field to the gel.

The nanometer sized guest species incorporated into the self assembled gel may have semiconductive, catalytic, magnetic, photoluminescent or electroluminescent properties. These compositions may be used for a variety of applications including sensors and catalysts. One application of the compositions is a lasing medium that includes dispersed nanometer size luminescent guest species that have been stably oriented in the DRC nanoribbons formed by the self assembling molecules. This lasing medium composition could be deposited as a layer and form the laser cavity portion of a thin film laser or microlaser.

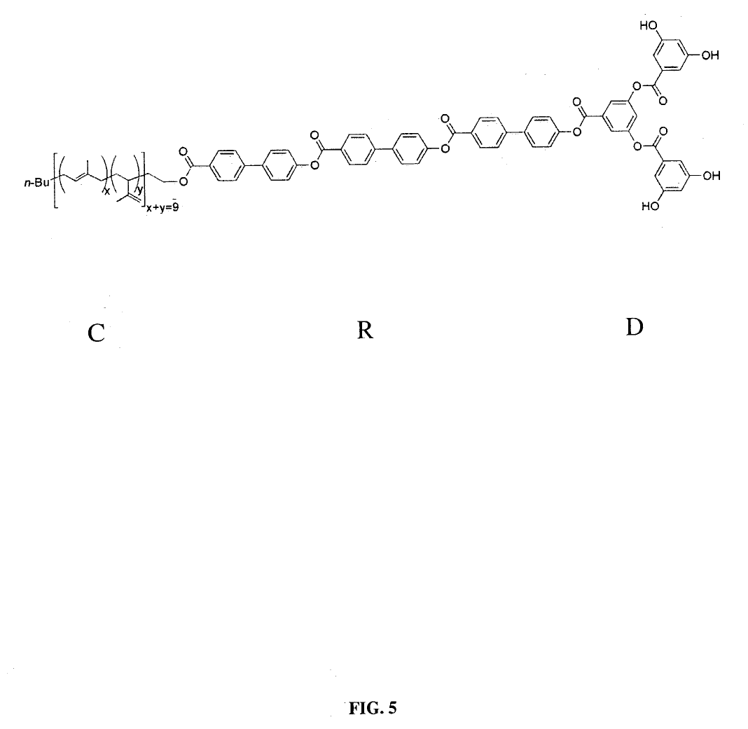

The self assembling molecules of the present invention form one dimensional such as nanofibers or nanoribbons. Preferably the one dimensional supramolecular structure is a nanoribbon form by self assembly of dendron rodcoil molecules, DRCs. DRCs have a general structure as shown by the non-limiting example of FIG. 5 wherein D is a dendritic block, R is a rod block, and C is a coil block, and wherein the bonds joining the D, R, and C blocks are covalent bonds. Preferred embodiments of the present invention have the general structure DRC. The DRC self-assembling compounds are capable of forming a birefringent gel when added to an organic medium. This is described in U.S. application Ser. No. 09/667,338 and WO 01/21678, the disclosures of both are incorporated herein by reference in their entirety.

As illustrated hereafter, the DR;C molecules have a tendency to aggregate, which is attributed to the rigid rod block and flexible coil block of the compound. The DRC compounds also resist packing in three dimensions because the branched structure of the dendritic block prevents stacking of DRC molecules. The DRC compounds, therefore, associate to form a ribbon-like aggregate. These ribbon-like aggregates form particularly attractive surfaces for interacting with elongated guest species such as but no limited to nanocrystals and dye molecules.

The coil block, C, in the DRC is linear and flexible, and may be an oligomer or polymer comprising one or more low molecular weight monomers. Block C has a weight average molecular weight (MW) of about 200 to about 10,000, and preferably about 200 to about 5,000. Preferably block C has a MW of about 200 to about 2,000. The beneficial properties of the C block, for example helping provide a capability for the DRC compounds to aggregate, have a tendency to decrease as the MW of the C block increases. However, this decrease in beneficial properties is overcome by simultaneously increasing the MW, of the R block.

As stated above, a function of the C block is to promote aggregation of DRC molecules. The C block is linear and unbranched, which allows the C blocks of DRC molecules to come in close proximity to one another. The C block, therefore, comprises monomers that preferably are unsubstituted, or substituted with small moieties, which allows individual DRC molecules to come in close proximity to form a molecular ribbon of DRC molecules. Large substituent moieties on the monomers comprising the C block, which hinder aggregation of DRC molecules, typically are avoided. The branched D blocks prevent intimate contact and entanglement of the C blocks of neighboring DRC molecules.

The monomers comprising the C block, therefore, can be any low molecular weight monomer that provides a flexible oligomer or polymer. If a hydrophobic C block is desired, the monomer can be ethylene, propylene, vinyl methyl ether, or a chlorinated or fluorinated vinyl monomer, e.g., vinyl chloride or vinylidene fluoride, for example. A hydrophilic C block can be prepared from a monomer like ethylene oxide or aziridine, for example.

The flexible oligoisoprene C block of a DRC compound contains, on average, about 9 monomeric isoprene units, and is structurally diverse, primarily containing the 3,4 addition product of isoprene. The C block imparts solubility to the DRC compound, thereby allowing a self assembly process to occur in solution or in the melt. The geometry of the dendron block D, and the noncrystallizable nature of the coil block C, facilitates formation of one-dimensional self-assembled structures, or scaffolds, i.e., ribbons of bimolecular species of DRC molecules. The essentially identical aromatic rod dendron blocks of the DRC compound strongly drive aggregation through non-covalent π-π interactions. The four hydroxy groups located on the periphery of dendritic block D provide an additional driving force for self-assembly of DRC compound molecules through the formation of hydrogen bonds between DRC molecules. Without wishing to be bound by theory, it is also believed that they assist the aggregate in attracting guest species such as nanocrystals of ZnO.

The C block may also have reactive groups for use in a subsequent reaction, such as, for entering into a polymerization reaction with an organic monomer. Such a reactive C block is prepared from monomers like isoprene and butadiene, which provide a C block having carbon-carbon unsaturation. Reactive groups also can be present in the C block as pendant substituents on the backbone of the C block. For example, the C block can have hydroxy, amino, carboxy, or cyano groups as pendant substituents. The C block also can have other small, nonreactive, pendant substituents, like for example methyl, ethyl, isopropyl, isopropenyl, halo (especially F or Cl), and CF₃.

The rod block, R, is linear and rigid, and is an oligomer or polymer of a monomer that provides a rigid polymeric structure. Block R has a MW of about 200 to about 10,000 , and preferably about 200 to about 5,000. Even more preferably the block R has a MW of about 200 to about 2,000.

A function of the R block, like the C block, is tozpromote aggregation of DRC molecules to form a molecular ribbon of DRC molecules. Aggregation and ribbon formation is adversely affected if the MW of the C block is too large. However, this adverse affect can be overcome by increasing the length, i.e., MW of the R block. It has been found that a ratio C block monomer units to R block monomer units of about 2:1 to about 9:1, and preferably about 2.5:1 to about 3.5:1, provides preferred DRC compounds with respect to aggregation, forming a molecular ribbon, and imparting order upon exposure to an electric field.

The R block comprises one or more monomers that provide a rigid polymer. One such monomer, for example, is acetylene and various substituted acetylenes, which provides a rigid polymer having alternating double and single bonds. The carbon-carbon double bonds of polyacetylene impart rigidity to block R, and provide reactive sites on the R block. Other monomers useful in providing the rigid R block are bi-functional phenyl monomers and or biphenyl monomers having a functional group on each phenyl ring. While not wishing to be bound by theory, it appears the functional groups aid-in the interaction with the guest species or nanocrystals.

In a preferred embodiments and in order to promote aggregation of DRC molecules into a bimolecular ribbon, the R block is not branched. This feature allows the R blocks of the DRC molecules to come in close proximity to one another, which assists aggregation because of π-π interactions between R blocks on neighboring DRC molecules.

The dendritic block D is branched and is prepared by reacting functional groups on the R block and/or C block with a suitably functionalized compound to incorporate branches into the DRC compound. The branched D block prevents DRC compounds from stacking in three dimensions, but allows the DRC compounds to aggregate and form a one-dimensional nanoribbon.

The compound used to incorporate branching into the DRC compound typically is a polyfunctional aromatic compound having a substituent capable of condensing with a substituent on the R or C blocks, and having additional substituents for further branching. A compound used to form the D block also can contain nonreactive substituents, like CF₃. In preferred embodiments, the D block is more hydrophilic than the R block, which again assists in aggregation of the DRC compounds, for example by facilitating π-π interactions between aromatic rings in the R blocks of individual DRC molecules, and by promoting association of DRC molecules to form the bimolecular species comprising the ribbon by interactions such as hydrogen bonding through the D blocks. Increased hydrophilicity typically is achieved by having hydroxy substituents or other hydrogen bonding moieties present on the D block.

The self assembled DRC molecules form a gel that includes one dimensional structures. The one dimensional structures in the gel have a width typically on the order of about 10-20 nanometers and lengths which may be on the order of tens of microns; the width of the ribbon structures ultimately depends upon the size of the DRC molecule. The length to width aspect ratio of such one dimensional structures can be as high as 1000. Preferably the one dimensional structures in the gel formed by the self assembled molecules are capable of being oriented by an electric field and as such may be charged or have a dipole induced by the electric field. FIG. 5 illustrates a particular useful DRC compound in accordance with the present invention. Reference is made again to U.S. application Ser. No. 09/667,338 and WO 01/21678 for a typical synthetic scheme to this and other dendron rod coil compounds suitable in the present invention. Also incorporated herein by reference in its entirety are the teachings of Zubarev et. al J. Am. Chem. Soc.(2001), vol 123, pp 4105. Various organic solvents may be used to form the gels and may be used to control the rate of the gel formation. Such solvents include but are not limited to styrene, 2-propanol, ethyl acetate, or EHMA.

Guest species may be dispersed within the gel in an essentially uniform or homogeneous manner. The guest species may include a mixture of different guests having desired properties. Approximately equal weight percentages, from about 0.2 to about 2 wt %, of DRC molecules and the guest species may be combined to form a mixture. The mixture may be sonicated and or heated to form a homogeneous mixture of the solvent, DRC molecules, and the nanometer sized guest species. The mixture may be poured into a suitable vessel and allowed to form a gel accompanied by incorporation and distribution of the guest species into the gel.

Molecules, nanocrystals, clusters, or other guest species may be incorporated into the gel formed by the ribbons. These species may have spherical, pyramidal, or elongated linear or rod like structures with their largest dimension less than about 1000 nanometers and preferably less that about 200 nanometers. Preferably the guest species have an elongated shape and more preferably have a dipole or other moment that lies along the extended axis of the guest species. The guest species may have electrical, electroluminescent, photoluminescent, or magnetic properties that are enhanced by alignment of their axes. Non-limiting examples of elongated shaped nanocrystal guest species include metal oxides such as αFe₂O₃, TiO₂, and semiconductors such as ZnO. Non-limiting examples of elongated or linear molecules include those with chromophores like disperse red 1 (DR1) which is an azobenzene dye, and molecules containing conjugated phenylene vinylene segments. Certainly, one ordinarily skilled in the art can identify other useful nanocrystals, clusters, colloids, or molecules which would be similarly attracted to the self-assembling molecules and which may also be distributed and/or oriented within the gel.

The self-assembling molecules form ribbons dispersed throughout the organic solvent media and thus form a gel material. Nanocrystals, molecules, oligomers, or clusters interact with the self assembled ribbons so that a substantially homogeneous dispersion of the guest species throughout the gel is achieved. The dispersion of the guest species within the gel can occur without active mixing during gelation.

Poling of the gel in an electric field including the guest species induces the alignment of the DRC nanoribbon with the electric field. The electrophoretic motion of the nanoribbon and guest species in the electric field orients the ribbons and the guest species. Direct current field strengths sufficient to orient the nanoribbons and guest species in the gel for their intended application may be used, preferably the electric field strength does not cause overheating or convection currents in the gel; more preferably electric field strengths between about 1,500 to 15,000 V/cm may be used.

Supramolecular ribbons formed by self assembly of the DRC molecules in organic solvents can form birefringent gels. Incorporation of a guest species into these gels also results in birefringent gels including the guest species. Luminescent guest species incorporated into the birefringent gels have their emission polarized by the poled birefringent gel. Birefringence is a property that is well known to persons skilled in the art of ordered materials, such as liquid crystals, and its measurement is a standard methodology used to determine whether a material exhibits long-range orientational or positional order. As illustrated hereafter, a material that exhibits birefringence is ordered, i.e., has a long-range molecular orientation or has domains of oriented molecules. Birefringence of a material is demonstrated using a bipolar microscope, wherein an ordered material rotates incident light from the microscope when the light is transmitted through the material. Materials that lack order, i.e., are amorphous or glassy, appear dark when viewed through a bipolar microscope.

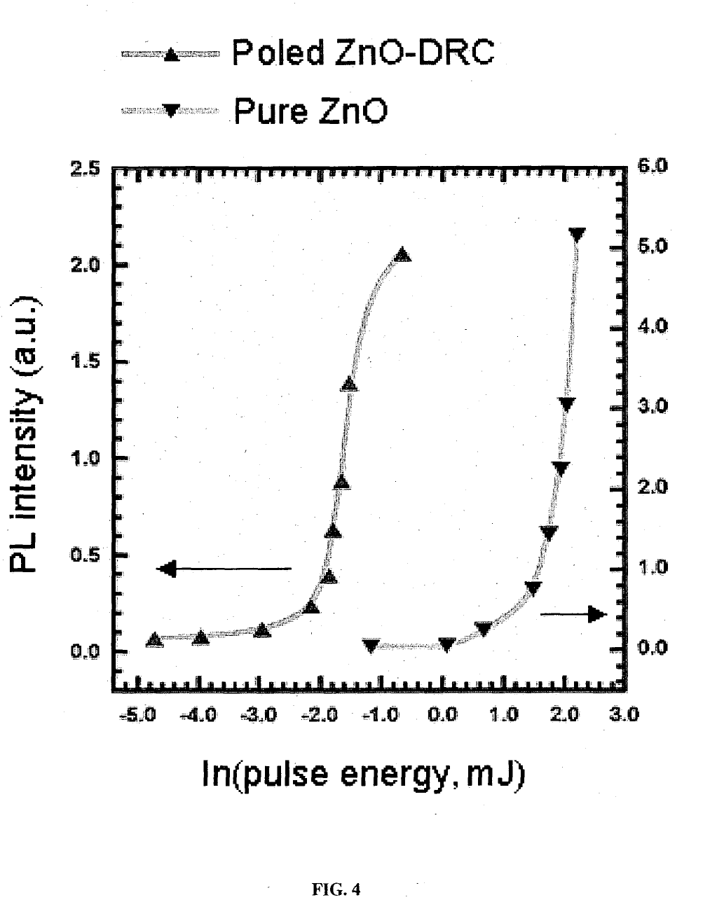

A lasing media may be formed by incorporation of a semiconductor nanocrystal such as ZnO into a ribbon polymer gel composition of the present invention and subsequently orienting the combination by electrophoresis to give an inorganic crystal hybrid ultraviolet (UV) lasing media. Dendron rod coil (DRC) molecules form gels with appropriate solvent or monomer wherein they self-assemble into nanoribbons with high aspect ratio. DRC nanoribbons disperse the ZnO nanocrystals (and other nanocrystal guest species) stably and evenly into the gel matrix. When subject to a DC poling electric field, the gel undergoes electrophoresis, resulting in the exclusion of the organic solvent monomer from the gel and the formation of a solid thin film consisting mostly of oriented DRC nanoribbons and ZnO nanocrystals, both having their axis oriented along the poling field. Electrophoresis is used in the sense that the ribbons that make up the gel are driven to an electric pole based upon their size and/or polarity. The poled DRC-ZnO film generates UV lasing emissions which are highly polarized and which have a much-lowered lasing threshold compared with pure ZnO nanocrystals as illustrated in FIG. 4. This methodology creates a hybrid material with one-dimensionally oriented nano-scaled components.

Potential applications of the present invention include fabrication of oriented UV micro-lasing media using self-assembly and low electric fields applied through micro-scale electrodes. A laser which has a thin film lasing medium of the present invention may be made using the teachings of U.S. Pat. No. 6,574,249 and U.S. Pat. No. 6,396,860 the disclosures of which are incorporated herein by reference in their entirety.

The present invention will be further understood by reference to the following non-limiting examples.

### EXAMPLE 1

ZnO nanocrystals were purchased from Nanophase Technologies Corp., Illinois. Most of them are rod-shaped single crystals as decided by TEM and electron diffraction. The size distribution is from ˜20 to-˜70 nm. Similar ZnO nanocrystals may also be synthesized using literature procedures.

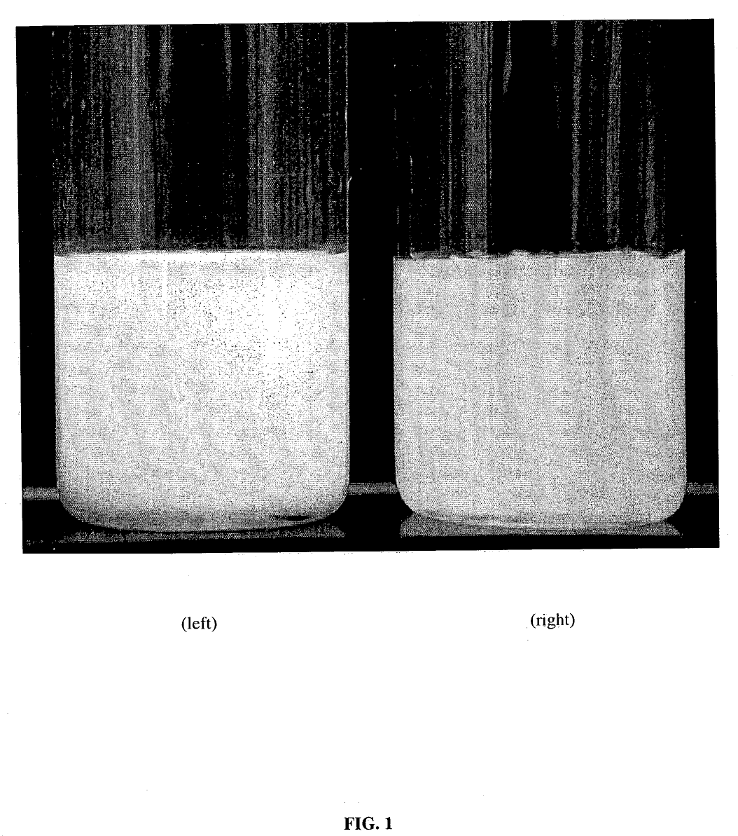

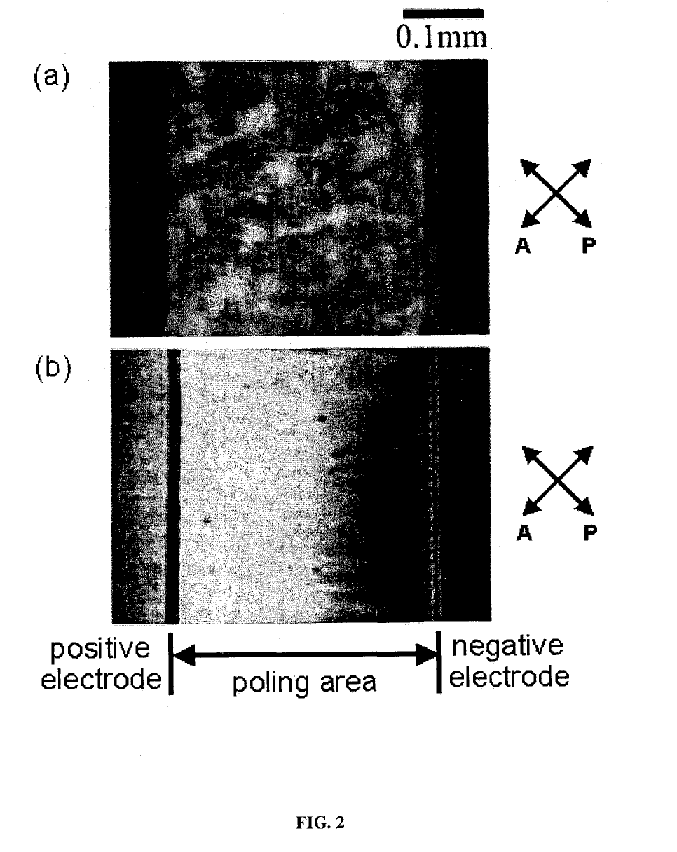

Same weight percentage (from 1 wt % to 2 wt %) of DRC molecules and ZnO nanocrystals were added to 2-ethylhexyl methacrylate (EHMA) monomer. The mixture was ultrasonicated for 20˜30 minutes, and then heated in 80° C. water bath for 20˜30 minutes. Precipitation of ZnO powders was visible at the vial bottom several minutes after the sonicating and heating. Without disturbance, the mixture turned into a gel within one day, and most of the previous ZnO precipitation disappeared from the vial bottom. It appears that as the nanoribbons form throughout the organic media that ZnO particles are picked up against gravity. FIG. 1 illustrates a 2 wt % ZnO-2 wt % DRC-EHMA gel (left) appears whiter and less translucent than a 2 wt % DRC-EIIMA gel without dispersed ZnO nanocrystals (right). The vertical distribution of ZnO nanocrystals is fairly homogeneous in the gel. Conducting indium tin oxide (ITO) layer coated on glass was etched to form two poling electrodes separated by a 0.3 to 2 mm wide strip of bare glass surface. The gel was applied to the poling area between the electrodes with thickness of ˜1 mm. Poling field strength between 1,500 V/cm and 15,000 V/cm was adopted, and the field should not be too high to cause overheating or convection currents. FIG. 2 illustrates poling of a 2 wt % DRC-EHMA gel with a 1500 V/cm electric field. Before subject to the field, the gel contains randomly oriented domains (a) as observed with an optical microscope with crossed polarizer (P) and analyzer (A). After poling for one day (b), an oriented DRC thin film is formed showing unidirectional birefringence. The maximum light transmission occurs when the poling direction forms a 45° angle with the crossed polarizer/analyzer pair in the microscope (b). The poled DRC-ZnO thin film was uniaxially birefringent. TEM measurements of ultramicrotomed samples strongly suggested that DRC nanoribbons were aligned preferentially along the poling direction by the poling field. Electrophoretic movement in the gel was induced by the field, causing the EHMA solvent to flow to the negative electrode where it evaporated. Poling for one day resulted in a film containing mostly DRC nanoribbons and ZnO nanocrystals.

The poled DRC-ZnO film underwent absorption anisotropy, second harmonic generation (SHG), and optical (lasing) emission measurements. The absorption anisotropy was measured with a Cary 500 double beam UV-VJS-NIR spectrophotometer. The probe beam was p-polarized, and the sample poling direction was either parallel or perpendicular to the probe light polarization during the measurement. SHG signals from the embedded ZnO nanocrystals were obtained with a Q-switched Nd:YAG laser (1064 nm, 10 Hz, 5 ns). Optical emissions in UV range from the ZnO nanocrystals were generated with a Q-switched Nd:YAG laser (355 nm, 10 Hz, 35 ps).

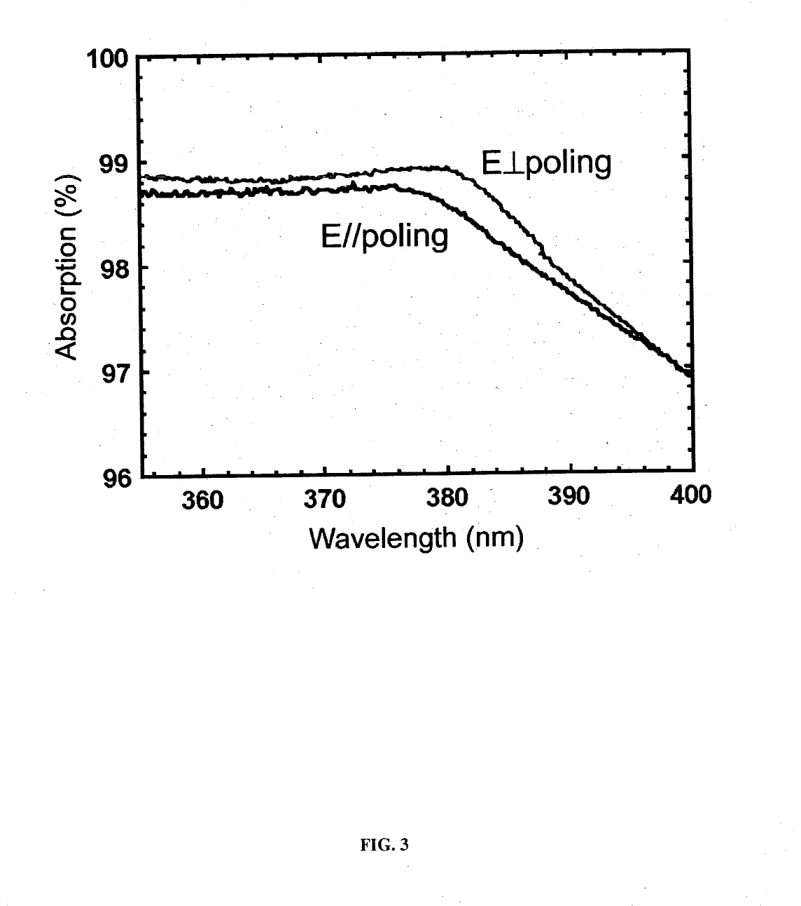

FIG. 3 illustrates absorption (%) anisotropy (shift) for the ZnO nanocrystals embedded in the poled DRC nanoribbon film, with the electric field, E, of the probe light either parallel (E//poling) or perpendicular (E ⊥ poling) to the poling direction. Absorption shift and SHG data suggested that c-axes of the ZnO nanocrystals were preferentially aligned parallel to the poling field.

The intensity of the UV emissions from the ZnO nanocrystals increased with the pumping intensity, showing a lasing threshold. Above the threshold the emissions were highly polarized. When the pumping was high, the (lasing) spectra were extremely narrow. FIG. 4 illustrates increasing pumping powers (in pulse energy) inducing emission intensity growth from the embedded ZnO nanocrystals in the poled DRC-ZnO film, and from the control sample of pure ZnO nanocrystals. The peak intensity (a.u.) vs. In of pumping pulse energy (mJ) is plotted. Compared with pure ZnO nanocrystals, the poled DRC-ZnO film had a 40±7 time lower lasing threshold.

### EXAMPLE 2

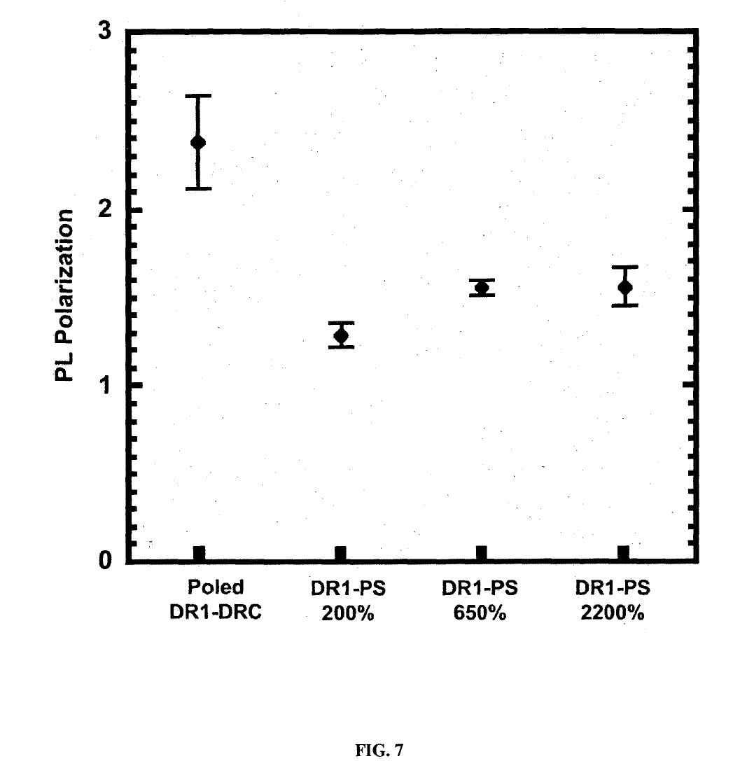

Small weight percentage of certain dye molecules, such as disperse red 1 (DR1), were dissolved in the gel. Similar electrophoresis creates hybrid films of unidirectionally oriented DRC nanoribbons and DR1 molecules. Strong emission polarization was obtained from the embedded DR1 dyes, significantly larger than that obtained from DR1-polystyrene samples stretched up to 22 times their original length (see FIG. 7). The emission polarization is defined as the ratio of the parallel PL component to the perpendicular PL component, both with respect to the poling direction. No obvious decrease in emission polarization was observed after the nanoribbon-DR1 films were annealed at 100° C.

### EXAMPLE 3

Small weight percentages of dissolved small molecules containing conjugated phenylene vinylene segments in DRC gels were prepared and exposed to DC electric fields. This process leads to thin films of unidirectionally oriented DRC nanoribbons and electroluminescent phenylene vinylene molecules. Light emitting diodes (LEDs) were fabricated by sandwiching the films between ITO and aluminum electrodes. The electroluminescence (EL) from these LEDs is anisotropic, with a parallel EL component (parallel to the poling direction) significantly stronger than that perpendicular to the electric field. As a comparison, EL was found to be isotropic from LEDs made of spin-coated films using the same molecular components.

The poled DRC-ZnO film generates Uv lasing emissions, with a much-lowered lasing threshold compared with pure ZnO nanocrystals. This is a novel approach to create hybrid materials with one-dimensionally oriented nano-scaled components. Potential applications include fabrication of oriented UV micro-lasing media using self-assembly and low electric fields applied through micro-scale electrodes.

The poled DRC-dye films generate polarized PL and EL. Potential applications of these polarized PL and EL compositions include energy efficient displays since no polarizers would be needed, and LEDs producing intrinsically polarized light. Poled DRC-species may be used in non-linear optical applications such as SHG-active materials and wave guide modulators.

The dispersion of the guest species throughout the gel during the self assembly and gelation process advantageously eliminates the need for continuous mixing during the formation of the gel. Another advantage of the present invention is that poled nanoribbon guest species compositions, such as the poled ZnO-DRC gel, will not relax upon heating, as may occur with chromophores poled in thermoplastic matrices, and is advantageous in terms of its stability.

All of the embodiments disclosed and claimed herein can be made and executed without undue experimentation in light of the present disclosure. While the compositions and methods of this invention have been described in terms of preferred embodiments, it will be apparent to those of skill in the art that variations may be applied to the composition, methods and in the steps or in the sequence of steps of the method described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention. The self-assembled material may have potential applications as biomaterial scaffolds for tissue engineering or drug delivery, coatings for carbon nanotubes for improved manipulation, or as templates for the growth of inorganic minerals.

While the principles of this invention have been described in connection with specific embodiments, it should be understood clearly that these descriptions are added only by way of example and are not intended to limit, in any way, the scope of this invention. For instance, various DRC related compounds have been described in conjunction with specific function. Likewise, while the present invention has been described as applicable to lasing materials, it is also contemplated that gels or related systems of such DRC compounds and guests can be used as a delivery platform or that the composition may be incorporated into other polymers. Other advantages and features will become apparent from the claims filed hereafter, with the scope of such claims to be determined by their reasonable equivalents, as would be understood by those skilled in the art.

What is claimed is:

1. A self-assembled composition comprising:
a guest species; and
self-assembling molecules, said self-assembling molecules forming a self-assembled structure having an elongated structure.

2. The composition of claim 1 wherein the self assembling molecule is a dendron rod coil.

3. The composition of claim 1 wherein the self assembled structure is a ribbon.

4. The composition of claim 1 wherein the self assembled structure forms a gel that is birefringent.

5. The composition of claim 1 wherein the guest species is luminescent.

6. The composition of claim 1 wherein said guest species is distributed within said self assembled structure.

7. The composition of claim 1 wherein an axis of said guest species and an axis of said self assembled structure are aligned with one another.

8. The composition of claim 1 wherein the guest species is ZnO.

9. The composition of claim 1 further comprising an organic solvent.

10. A method of dispersing guest species in a gel comprised of:
self-assembling molecules into said gel to thereby disperse said guest species within said gel.

11. The method of claim 10 wherein said self assembling molecules form nanoribbons.

12. The method of claim 10 wherein said gel is birefringent.

13. The method of claim 10 wherein the self assembling molecules are dendron rodcoils.

14. The method of claim 10 wherein the guest species is luminescent.

15. A method for orienting a guest species in gel comprising:
applying an electric field to a combination of self assembling molecules and guest species.

16. The method of claim 15 wherein the self assembling molecules form one dimensional structures.

17. The method of claim 15 wherein the guest species are dispersed within said gel.

18. The method of claim 15 wherein a solvent is removed from the combination of self assembling molecules and guest species by the application of said electric field.

19. A lasing medium comprising:
a luminescent guest species dispersed in a gel, said gel formed by self assembled molecules.

20. The lasing medium of claim 19 wherein the guest species includes ZnO.

21. The lasing medium of claim 19 wherein the self assembled molecules include dendron rodcoils.
